(19) United States
(12) Patent Application Publication
(10) Pub. No.: US 2026/0091418 A1
(43) Pub. Date: Apr. 2, 2026

(54) CLEANING SYSTEMS AND ASSOCIATED METHODS FOR EXTRACTION OR VENTILATION DUCTS

(71) Applicant: Probionate Limited, County Kildare (IE)

(72) Inventors: Gregory Cunningham, Glasgow Strathclyde (GB); Alistair Little, County Kildare (IE)

(21) Appl. No.: 19/111,723

(22) PCT Filed: Sep. 13, 2023
(86) PCT No.: PCT/EP2023/075183

§ 371 Date: Mar. 13, 2025

(30) Foreign Application Priority Data
Sep. 14, 2022 (GB) 2213473.8

(51) Int. Cl. B08B 9/032; B05B 7/04; B05B 7/24; B08B 17/02

(52) U.S. Cl. CPC B08B 9/0327; B05B 7/2491; B08B 9/0325; B08B 9/0328; B08B 17/02; B05B 7/0483

(57) ABSTRACT

A cleaning system (100) for preventing the build-up of fats, oils and/or greases in extraction and ventilation ducts. The cleaning system comprises: a pressurised gas source (102), a fluid supply tank (104) for containing a cleaning fluid, the fluid supply tank comprising a tank gas inlet (110) fluidly connected to the pressurised gas source and a tank fluid outlet (112), a nozzle (106), wherein the nozzle comprises a nozzle gas inlet (114), a nozzle fluid inlet (116) and a nozzle outlet (118), and wherein the pressurised gas source (102) is fluidly connected to the nozzle gas inlet (114) and the fluid supply tank outlet (112) is fluidly connected to the nozzle fluid inlet (116), and a controller (108), the controller configured to control flow of gas from the pressurised gas source to the fluid supply tank gas inlet, and to the nozzle gas inlet. A method of installation of the cleaning system (100) for extraction and ventilation ducts comprising: providing the cleaning system (100), and locating the nozzle (106) in a duct of the extraction and ventilation ducts. A method of preventing the build-up of fats, oils or grease on an internal surface of a ventilation or extraction duct, the method comprising: providing the cleaning system (100) and operating the cleaning system, via the controller (108) to expel the cleaning fluid from the nozzle outlet (118) into the ventilation or extraction duct.

### TECHNICAL FIELD

The present disclosure relates to cleaning of extraction or ventilation ducts and particularly, but not exclusively, bacterial cleaning of extraction or ventilation ducts for inhibiting the build-up of fats, greases and oils within the ducts.

### BACKGROUND

Commercial kitchens require adequate smoke and vapour ventilation and extraction ducts. These extraction and ventilation ducts are prone to fat, oil, grease and carbon build up on the internal walls and components which can impact efficiency of the systems and present a fire risk. Many fires in commercial kitchens are caused by such deposits of fat/oil/grease/carbon inside extraction and/or ventilation ducts.

The current method of removing these deposits is manual deep cleaning either by hand or using brushing machines. However, this manual cleaning is difficult and time intensive and it can be difficult and sometimes impossible, to check that the deposits have been successfully removed.

### SUMMARY

There is provided a cleaning system for preventing the build-up of fats, oils and/or greases in extraction and ventilation ducts, the cleaning system comprising: a pressurised gas source, a fluid supply tank for containing a cleaning fluid, the fluid supply tank comprising a tank gas inlet fluidly connected to the pressurised gas source and a tank fluid outlet, a nozzle, wherein the nozzle comprises a nozzle gas inlet, a nozzle fluid inlet and a nozzle outlet, and wherein the pressurised gas source is fluidly connected to the nozzle gas inlet and the fluid supply tank outlet is fluidly connected to the nozzle fluid inlet, and a controller, the controller configured to control: flow of gas from the pressurised gas source to the fluid supply tank gas inlet, and to the nozzle gas inlet.

The cleaning system operates to prevent build up of fats, oils and/or greases. However, it will be appreciated that use of the cleaning system in a vent also removes built-up fats, oils and/or greases that may be present. It will be appreciated that, while the disclosed system and methods are suitable for preventing build up of fats, oils and/or greases in extraction and ventilation ducts, the systems and methods may be implemented in other locations in the extraction and ventilation systems, such as a canopy, fan, plenhem chamber or fan housing. The systems and methods will prevent build up of fats, oils and/or greases in all of these locations in the extraction/ventilation system whether installed in the ducts, or in another location in the extraction/ventilation system.

Optionally, the cleaning system is configured to expel fluid from the fluid supply tank and gas from the pressurised gas source through the nozzle outlet as a fog. Optionally, the cleaning system is configured to expel fluid from the fluid supply tank and gas from the pressurised gas source through the nozzle outlet with an average droplet diameter of less than 40 micron. The nozzle may be a venturi nozzle.

Optionally, the nozzle comprises a valve, operable between a closed position in which the valve closes the fluid inlet and the gas inlet of the nozzle and an open position in which the fluid inlet and the gas inlet are open. Optionally, the valve is biased towards the closed position. The valve may be a pin valve and may be biased by a spring towards the closed position.

Optionally, the valve is configured to receive a bias-opposing force from gas arriving at the gas inlet of the nozzle and the pressurised gas source is configured to provide sufficient pressure at the nozzle gas inlet to move the valve to the open position. For example, the pin valve may have a surface that blocks the nozzle gas inlet in the closed position, the surface oriented such that pressure supplied by gas arriving at the nozzle gas inlet provides a force on the surface, the force being in the direction of the open position. The surface may be slanted.

Optionally, the gas nozzle inlet receives air from the pressurised gas source via a 6 mm diameter hose. Optionally, the nozzle fluid inlet receives fluid, such as a liquid enzyme product via a 4 mm diameter hose.

Optionally, the nozzle tip may have an angle, may be narrow, may be cone-shaped and/or give the expelled fog a direction. These features of the nozzle may be modified to best suit the fogging area within the extraction or ventilation duct. The nozzle outlet may have a diameter of between 0.1 mm and 1 mm.

Optionally, the pressure of the gas at the nozzle gas inlet opens the valve, thereby allowing fluid to enter the nozzle from the nozzle fluid inlet. The gas and fluid mix to produce the fog.

The pressure of the gas arriving at the nozzle inlet may be adjusted to optimise the size of the droplets within the fog for the fogging area. Optionally, the cleaning system is configured to provide a pressure at the nozzle gas inlet of between 1 and 4 bar, optionally between 3 and 4 bar, for example, 3.5 bar. The pressure supplied by the pressurised gas source may be adjusted to account for the length of pipes utilised between the source and the nozzle gas inlet.

Optionally, the cleaning system is configured to provide a pressure at the fluid inlet of between 1 and 1.5 bar, for example, 1.5 bar. An example fog has particles of, on average, 38 micron and is produced with an air pressure of 3.5 bar and a fluid pressure of 1.5 bar.

Optionally, the cleaning system is configured to provide a pressure at the tank gas inlet of between 3 and 4 bar, for example 3.5 bar.

The cleaning system may comprise a regulator for pressure supplied to the nozzle gas inlet. e cleaning system may comprise a regulator for pressure supplied to tank gas inlet. The pressurised gas source may be configured to provide a pressure of 3 to 4 bar to the nozzle gas inlet. The pressurised gas source may be configured to provide a pressure of 3 to 4 bar to a fluid solenoid which adjusts the pressure to deliver a lower pressure, for example, 1 bar, to the fluid tank.

Optionally, the pressurised gas source comprises a compressor. The pressurised gas source may comprise two compressors, one of which is connected to the tank gas inlet and the other connected to the nozzle gas inlet. The compressor(s) may be air compressor(s). The compressor(s) may produce 8 bar of pressure. The pressure provided by the pressurised gas source may be adjustable. The pressures delivered to the nozzle gas inlet, fluid tank gas inlet and/or the nozzle fluid inlet may each be adjustable. This allows the system to be adaptable to different sites, fogging areas and/or pipe lengths.

The tank may be a pressure vessel.

Optionally, the tank contains a cleaning fluid, such as a liquid enzyme product, for example, a multi enzyme cleaning fluid. The fluid tank may contain bacteria. The bacteria, once released into the extraction and ventilation ducts by the cleaning system will consume any fat, oil and grease present and so will clean any deposits already in the ducts and prevent the build-up of deposits in the ducts. The bacteria may comprise a bacterial culture, microbial spores or may take another form. The bacteria may be a fat, oil, carbon and/or grease consuming bacteria. The cleaning fluid may be, for example, Vent Degreaser manufactured by BioHygiene. The cleaning fluid may be food-safe and/or non-hazardous.

Optionally, the system further comprises a gas source valve configured to control flow of gas from the pressurised gas source and wherein the controller is connectable to the gas source valve to allow communication of a status of the gas source valve from the gas source valve to the controller and/or communication of a target status from the controller to the gas source valve.

Optionally, the system further comprises a fluid valve configured to control flow of fluid from the tank outlet and wherein the controller is connectable to the fluid valve to allow communication of a status of the fluid valve from the fluid valve to the controller and/or communication of a target status from the controller to the fluid valve.

The valves may be solenoid valves. The controller may be configured to control a flow of gas from the pressurised gas source to the fluid supply tank gas inlet by controlling a valve, such as a solenoid valve in the flow path between the pressurised gas source and the fluid supply tank gas inlet. The controller may be configured to control a flow of gas from the pressurised gas source to the nozzle gas inlet by controlling a valve, such as a solenoid valve in the flow path between the pressurised gas source and the nozzle gas inlet. The controller may be configured to open both valves simultaneously to allow flow of gas to the nozzle and to the fluid supply tank simultaneously. The controller may be further configured to control the flow of fluid from the tank fluid outlet to the fluid inlet of the nozzle. The controller may be configured to control the flow of fluid from the fluid tank to the nozzle fluid inlet by controlling a valve, such as a solenoid valve in the flow path between the fluid tank and the nozzle fluid inlet.

Optionally, the controller is configured to communicate with the gas source valve and the fluid valve to open the two valves according to a pre-programmed timetable to cause fluid from the tank to be expelled from the nozzle outlet.

Optionally, the system further comprises a tank pressure regulator being configured to control a pressure provided at the tank gas inlet, wherein the controller is communicatively connectable to the tank pressure regulator to allow communication of the pressure at the tank pressure regulator to the controller and communication of a target pressure to the tank pressure regulator.

Optionally, the system further comprises a nozzle pressure regulator being configured to control a pressure provided at the nozzle gas inlet, wherein the controller is communicatively connectable to the nozzle pressure regulator to allow communication of the pressure at the nozzle pressure regulator to the controller and communication of a target pressure to the nozzle pressure regulator.

Optionally, the system further comprises a fluid measurement means configured to measure the amount of fluid expelled from or amount of fluid within the tank. The fluid measurement means may be a fluid flow meter configured to measure fluid flow from the tank, or a weigh scale configured to measure the weight of the tank. The weigh scale may be configured to weigh the tank before and after a dose of the fluid is expelled from the tank and send the readings to the controller. The controller may be configured to calculate the difference in weight of the tank and convert the weight difference to an amount of fluid remaining in the tank and/or an amount of fluid expelled from the tank in the dose. This measurement may be used to predict when the canister will be empty. The controller may be communicatively connectable to the fluid measurement means to allow communication of the measurement to the controller.

Optionally, the controller is communicatively connectable to a software system and the controller is configured to send reports indicative of the performance of the system to said software system.

The controller may identify product levels and/or faults and/or dosage of the cleaning system. The controller may include the identified product level and/or faults in a report sent to the software system. The controller may be connectable to a local or remote user device for monitoring and/or controlling the cleaning system from the user device. The controller may be configured to communicate with a user device via a cabled connection or via wireless communication such as WiFi, Bluetooth, NFC or a network such as 3G/4G/5G, for example by utilising a SIM card. The user device may be a computer, mobile telephone, tablet or any other computing device. The controller may be configured to communicate with the user device indirectly, for example via a cloud-based system. By communicating over a network such as the internet, or a mobile network, the user device may be remote from the controller.

The cleaning system may further comprise a flow meter on the fluid supply pipe or the output pipe. The flow meter may be communicatively connected to the controller and the flow meter may be configured to send flow rate data to the controller. The controller may be configured to process the flow rate data to calculate an amount of fluid used by the cleaning system, optionally in a pre-set time period, such as a day.

Alternatively, the cleaning system further comprises a weigh scale configured to measure the weight of the tank. The weigh scale may be configured to weigh the tank before and after a dose of the fluid is expelled from the tank and send the readings to the controller. The controller may be configured to calculate the difference in weight of the tank and convert the weight difference to an amount of fluid remaining in the tank and/or an amount of fluid expelled from the tank in the dose. This measurement may be used to predict when the canister will be empty

The controller may be configured to report data indicative of the amount of fluid used in the system to a user device, optionally the report may be sent at the end of the pre-set time period. The data indicative of the amount of fluid used in the system may be a measure of the amount of fluid used, a prediction of the amount of fluid left in a fluid tank connected to the cleaning system based on the amount of fluid used by the cleaning system, and/or an alert to indicate the level of fluid in the fluid tank is low based on the amount of fluid used by the cleaning system. In this way, a cleaning fluid supplier may be notified that the cleaning system is running low on cleaning fluid. The report of data indicative of the amount of fluid used in the system may be triggered by a threshold amount of fluid used or a threshold amount of fluid predicted to remain in the fluid tank.

The controller may be configured to process the flow rate data to calculate an amount of fluid used in a dose. The controller may be configured to report data indicative of the amount of fluid used in a dose by the cleaning system to a user device. The controller may be configured to check whether the measured dose amount matches a pre-set value for the target dose amount and may store a result of the check. The controller may be configured to report the result of the check to the user device.

The methods of controlling and/or monitoring may be computer-implemented and may be performed wholly or partially by a user device such as a computer, tablet, and/or smart phone and/or may be performed wholly or partially by a cloud-based system which may be accessible by a user device.

The controller may communicate with the cloud-based system only. The cloud-based system may communicate with the controller and the user device. The user device may communicate with the cloud-based system. The controller may communicate with the user device. The controller may communicate both directly with the user device and indirectly with the user device via the cloud-based system. Multiple user devices may be used to communicate with the cloud-based system and/or the controller. Further the cloud-based system and/or the user device may communicate with controllers of multiple cleaning systems.

Such communication may be realised via a cabled connection or via wireless communication such as WiFi, Bluetooth, NFC or a network such as 3G/4G/5G, for example, utilising a SIM card.

The cleaning system may further comprise a power supply system configured to be isolated from the extraction or ventilation ducts to be cleaned. The power supply system may comprise a mains supply plug. The power supply system may further comprise a battery. In this way, the battery may be used as a backup power supply if the mains supply is interrupted. By isolating the power supply from the power supply of the extraction or ventilation ducts, cleaning may be performed at a time when the extraction or ventilation system is not in operation (such as at night).

The system may comprise more than one nozzle. Each of the nozzles may have the nozzle features described above. For example, each of the nozzles may have a respective nozzle gas inlet, nozzle fluid inlet and nozzle outlet. This allows nozzles to be placed at various different locations within an extraction or ventilation vent to distribute the fog throughout the vent. The system may have only two nozzles. This may provide an effective cleaning system with a minimal number of nozzles due to the use of the fog. The fog allows the fluid droplets to spread over a large area, thereby reducing the number of nozzles required. In large vent systems, more nozzles may be used.

There is further provided a method of installation of a cleaning system for extraction and ventilation ducts comprising: providing a cleaning system as described above, and locating the nozzle in a duct of the extraction and ventilation ducts.

There is further provided a method of preventing the build-up of fats, oils or grease on an internal surface of a ventilation or extraction duct, the method comprising: providing a cleaning system as described above and operating the cleaning system, via the controller to expel the cleaning fluid from the nozzle outlet into the ventilation or extraction duct.

There is further provided a method of installation of a cleaning system as described above and having at least two nozzles, the method comprising locating the nozzles in the extraction and/or ventilation vents, the second nozzle is located between 15 ft to 25 ft further up the air flow path from the first nozzle. Optionally, the first nozzle is located in a canopy or duct connected to the canopy.

The methods, devices and systems described above may be combined in any possible combination. The optional features described above are equally applicable to all of the described methods, devices and systems and are not limited to the particular method/device/system with which they are described here. The essential features of any of the methods/devices/systems described may be optional features of any other method/device/system described.

Further features and advantages of the present disclosure will become apparent from the claims and the following description.

### BRIEF DESCRIPTION OF DRAWINGS

Embodiments of the present disclosure will now be described by way of example only, with reference to the following diagrams, in which:

FIG. 1 shows a schematic diagram of a cleaning system for extraction or ventilation ducts;

FIG. 2A shows a section view of a nozzle of the cleaning system of FIG. 1 in the closed position;

FIG. 2B shows a section view of the nozzle of FIG. 4A in the open position;

FIG. 3 shows a schematic diagram of communication between the controller of the cleaning system of FIG. 1 and a user device and a cloud-based system; and

FIG. 4 shows a perspective view of components of a cleaning system installed in an extraction system.

### DETAILED DESCRIPTION

A number of different embodiments of the disclosure are described subsequently.

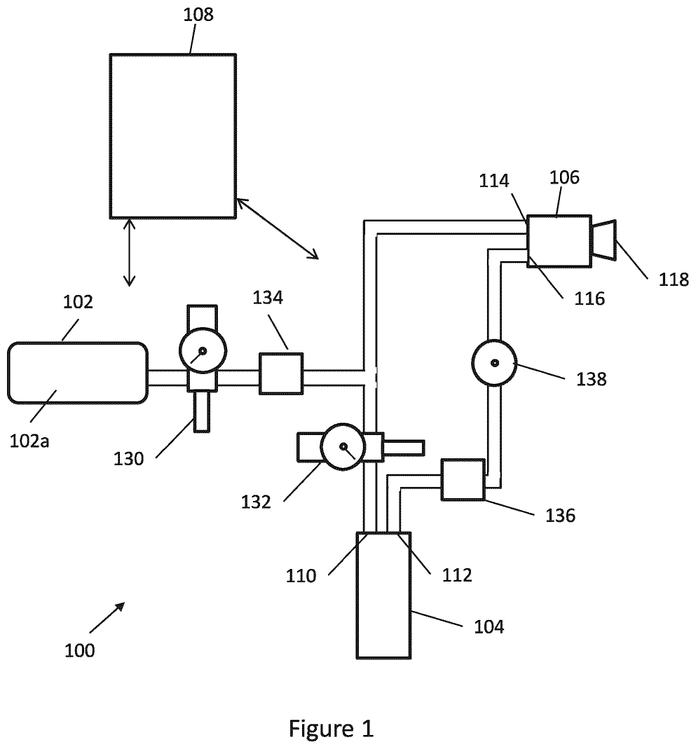

FIG. 1 shows a cleaning system 100 for preventing the build-up of fats, oils and/or greases in extraction and ventilation ducts. The cleaning system comprises: a pressurised gas source 102, a fluid supply tank 104 for containing a cleaning fluid, a nozzle 106, and a controller 108.

The fluid supply tank 104 comprises a tank gas inlet 110 fluidly connected to the pressurised gas source 102 and a tank fluid outlet 112. The nozzle 106 comprises a nozzle gas inlet 114, a nozzle fluid inlet 116 and a nozzle outlet 118. The pressurised gas source 102 is fluidly connected to the nozzle gas inlet 114 and the fluid supply tank outlet 112 is fluidly connected to the nozzle fluid inlet 116. The controller is configured to control flow of gas from the pressurised gas source 102 to the fluid supply tank gas inlet 110, and to the nozzle gas inlet 114.

The cleaning system is configured to expel fluid from the fluid supply tank 104 and gas from the pressurised gas source 102 from the nozzle outlet 118 as a fog.

The pressurised gas source comprises an 8 bar air compressor 102a. The cleaning system has a nozzle pressure regulator 130 for pressure supplied to the nozzle gas inlet 114 and a tank pressure regulator 132 for pressure supplied to tank gas inlet. Regulator 130 is a 10 bar regulator which is adjustable to 6.5 bar. Regulator 132 is adjustable to 1.5 bar. The regulators may be considered part of the pressurised gas source 102 along with air compressor 102a.

Tank 104 is a liquid pressure vessel and contains a cleaning fluid, such as a liquid enzyme product, for example, a multi enzyme cleaning fluid. The fluid tank may contain bacteria which may comprise a bacterial culture, microbial spores or may take another form. The bacteria may be a fat, oil, carbon and/or grease consuming bacteria. The cleaning fluid may be, for example, Vent Degreaser manufactured by BioHygiene. The cleaning fluid may be food-safe and/or non-hazardous.

Gas source valve 134 is configured to control flow of gas from the pressurised gas source 102 and fluid valve 136 is configured to control flow of fluid from the tank outlet 112.

The controller 108 is connectable to the gas source valve 134 to allow communication of a status of the gas source valve from the gas source valve to the controller and/or communication of a target status from the controller to the gas source valve and the controller 108 is connectable to the fluid valve 136 to allow communication of a status of the fluid valve from the fluid valve to the controller and/or communication of a target status from the controller to the fluid valve. The gas and fluid valves are solenoid valves.

The controller 108 is configured to communicate with the gas source valve 134 and the fluid valve 136 to open the two valves according to a pre-programmed timetable to cause fluid from the tank to be expelled from the nozzle outlet.

The controller 108 is communicatively connectable to the tank pressure regulator 132 to allow communication of the pressure at the tank pressure regulator to the controller and communication of a target pressure to the tank pressure regulator. The controller 108 is communicatively connectable to the nozzle pressure regulator 130 to allow communication of the pressure at the nozzle pressure regulator to the controller and communication of a target pressure to the nozzle pressure regulator.

The system further comprises a fluid flow meter 138 configured to measure fluid flow from the tank, wherein the controller 108 is communicatively connectable to the fluid flow meter to allow communication of the measured fluid flow to the controller. The flow meter also communicates whether the product is flowing to the controller 108.

The cleaning system 100 has a power supply system configured to be isolated from the extraction or ventilation ducts to be cleaned. The power supply system may comprise a mains supply plug. The power supply system may further comprise a battery. In this way, the battery may be used as a backup power supply if the mains supply is interrupted. By isolating the power supply from the power supply of the extraction or ventilation ducts, cleaning may be performed at a time when the extraction or ventilation system is not in operation (such as at night).

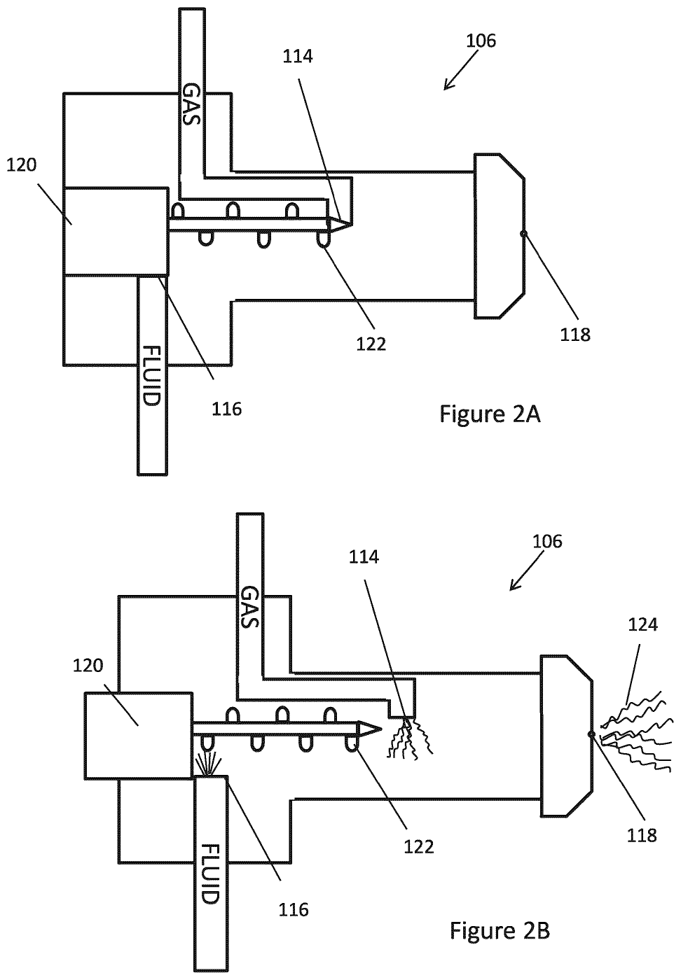

The nozzle is shown in more detail in FIG. 2A and FIG. 2B. The nozzle 106 comprises a pin valve 120. The valve 120 is operable between a closed position, shown in FIG. 2A, in which the valve 120 closes the fluid inlet 116 and the gas inlet 114 of the nozzle, and an open position, shown in FIG. 2B, in which the fluid inlet 116 and the gas inlet 114 are open. The valve 120 is biased towards the closed position by spring 122.

The valve 120 receives a bias-opposing force from gas arriving at the gas inlet 114 of the nozzle and the pressurised gas source 102 is configured to provide sufficient pressure at the nozzle gas inlet 114 to move the valve 120 to the open position shown in FIG. 2B. Thee pin 120 valve of this example has a slanted surface that blocks the nozzle gas inlet 114 in the closed position, the surface is oriented such that pressure supplied by gas arriving at the nozzle gas inlet provides a force on the surface, the force being in the direction of movement of the pin towards the open position. The nozzle outlet 118 has a diameter of between 0.1 mm and 1 mm.

When the pressure of the gas at the nozzle gas inlet opens the valve, thereby allowing fluid to enter the nozzle from the nozzle fluid inlet, the gas and fluid mix to produce fog 124 which is expelled from the nozzle outlet 118.

This example cleaning system is configured to provide a pressure at the nozzle gas inlet 114 of 3.5 bar and a pressure at the fluid inlet 116 of 1.5 bar. This, produces fog with droplet/particle sizes of, on average, 38 micron.

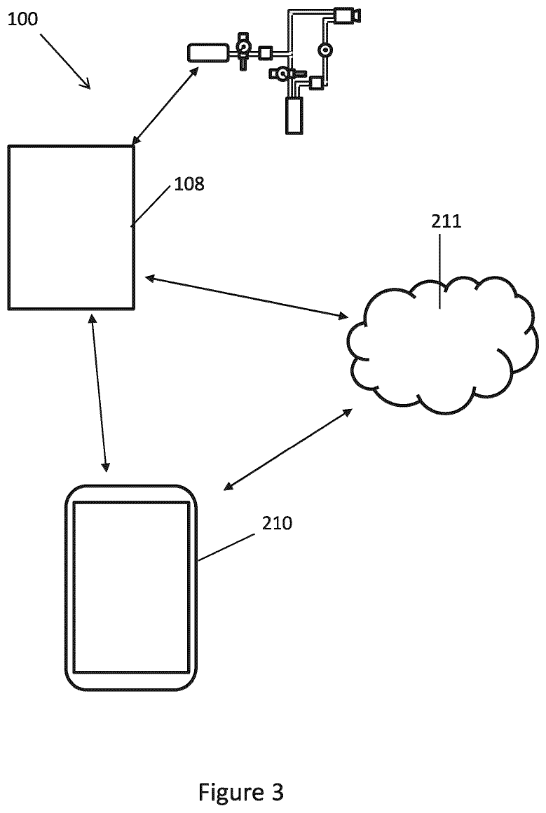

As shown in FIG. 3, the controller 108 is communicatively connectable to a software system, for example on a user device 210 and/or on a cloud-based system 211 and the controller 108 is configured to send reports indicative of the performance of the system to said software system.

The controller 108 may identify product levels and/or faults and/or dosage of the cleaning system. The controller may include the identified product level and/or faults in a report sent to the software system. The controller may be connectable to a local or remote user device 210 for monitoring and/or controlling the cleaning system from the user device. The controller may be configured to communicate with the user device 210 via a cabled connection or via wireless communication such as WiFi, Bluetooth, NFC or a network such as 3G/4G/5G, for example by utilising a SIM card. The user device 210 may be a computer, mobile telephone, tablet or any other computing device. The controller 108 may be configured to communicate with the user device 210 indirectly, for example via cloud-based system 211. By communicating over a network such as the internet, or a mobile network, the user device 210 may be remote from the controller.

The controller 108 is configured to process flow rate data received from the flow rate meter to calculate an amount of fluid used by the cleaning system, optionally in a pre-set time period, such as a day. The controller 108 may be configured to report data indicative of the amount of fluid used in the system to a user device, optionally the report may be sent at the end of the pre-set time period. The data indicative of the amount of fluid used in the system may be a measure of the amount of fluid used, a prediction of the amount of fluid left in a fluid tank connected to the cleaning system based on the amount of fluid used by the cleaning system, and/or an alert to indicate the level of fluid in the fluid tank is low based on the amount of fluid used by the cleaning system. In this way, a cleaning fluid supplier may be notified that the cleaning system is running low on cleaning fluid. The report of data indicative of the amount of fluid used in the system may be triggered by a threshold amount of fluid used or a threshold amount of fluid predicted to remain in the fluid tank.

The controller 108 may be configured to process the flow rate data to calculate an amount of fluid used in a dose. The controller 108 may be configured to report data indicative of the amount of fluid used in a dose by the cleaning system to a user device. The controller 108 may be configured to check whether the measured dose amount matches a pre-set value for the target dose amount and may store a result of the check. The controller 108 may be configured to report the result of the check to the user device 210.

The methods of controlling and/or monitoring may be computer-implemented and may be performed wholly or partially by user device 210 such as a computer, tablet, and/or smart phone and/or may be performed wholly or partially by cloud-based system 211 which may be accessible by user device 210.

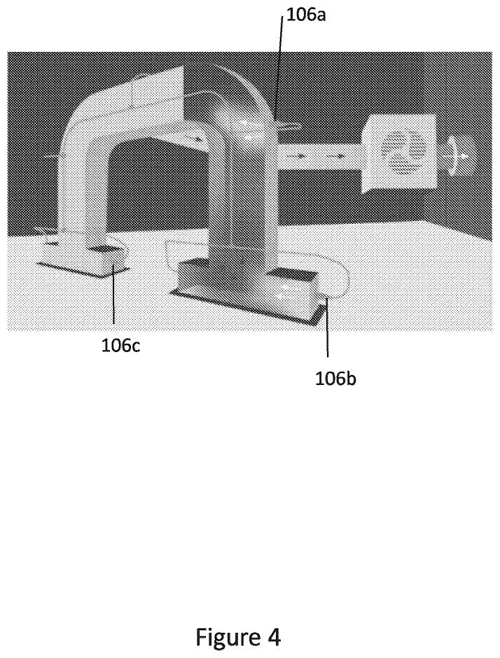

As shown in FIG. 4, the system 100 may comprise more than one nozzle. Each of the nozzles have the nozzle features described above. For example, each of the nozzles has a respective nozzle gas inlet, nozzle fluid inlet and nozzle outlet.

As shown in FIG. 4, nozzles 106a, 106b, 106c can be placed at various different locations within an extraction or ventilation vent to distribute the fog throughout the vent. This means that fog can be spread throughout the system without relying on fans within the extraction or ventilation system to be operating.

Although particular embodiments of the disclosure have been disclosed herein in detail, this has been done by way of example and for the purposes of illustration only. The aforementioned embodiments are not intended to be limiting with respect to the scope of the appended claims.

It is contemplated by the inventors that various substitutions, alterations, and modifications may be made to the invention without departing from the scope of the invention as defined by the claims.

1. A cleaning system for preventing the build-up of fats, oils and/or greases in extraction and ventilation ducts, the cleaning system comprising:
a pressurised gas source,
a fluid supply tank for containing a cleaning fluid, the fluid supply tank comprising a tank gas inlet fluidly connected to the pressurised gas source and a tank fluid outlet,
a nozzle, wherein the nozzle comprises a nozzle gas inlet, a nozzle fluid inlet and a nozzle outlet, and wherein the pressurised gas source is fluidly connected to the nozzle gas inlet and the fluid supply tank outlet is fluidly connected to the nozzle fluid inlet, and
a controller, the controller configured to control:
flow of gas from the pressurised gas source to the fluid supply tank gas inlet, and to the nozzle gas inlet.

2. A cleaning system according to claim 1, wherein the cleaning system is configured to expel fluid from the fluid supply tank and gas from the pressurised gas source through the nozzle outlet as a fog.

3. A cleaning system according to claim 1, configured to expel fluid from the fluid supply tank and gas from the pressurised gas source through the nozzle outlet with an average droplet diameter of less than 40 micron.

4. A cleaning system according to claim 1, wherein the nozzle comprises a valve, operable between a closed position in which the valve closes the fluid inlet and the gas inlet of the nozzle and an open position in which the fluid inlet and the gas inlet are open.

5. A cleaning system according to claim 4, wherein the valve is biased towards the closed position.

6. A cleaning system according to claim 5, wherein the valve is configured to receive a bias-opposing force from gas arriving at the gas inlet of the nozzle and the pressurised gas source is configured to provide sufficient pressure at the nozzle gas inlet to move the valve to the open position.

7. A cleaning system according to claim 1, wherein the nozzle outlet has a diameter of less than 1 mm.

8. A cleaning system according to claim 1, configured to provide a pressure at the nozzle gas inlet of between 1 and 4 bar.

9. A cleaning system according to claim 1, configured to provide a pressure at the fluid inlet of between 1 and 1.5 bar.

10. A cleaning system according to claim 1, configured to provide a pressure at the tank gas inlet of between 3 and 4 bar.

11. A cleaning system according to claim 1, wherein a pressure provided by the pressurised gas source is adjustable.

12. A cleaning system according to claim 1, wherein the tank is a pressure vessel.

13. A cleaning system according to claim 1, wherein the tank contains a multi enzyme cleaning fluid.

14. A cleaning system according to claim 1, the system further comprising a gas source valve configured to control flow of gas from the pressurised gas source and wherein the controller is connectable to the gas source valve to allow communication of a status of the gas source valve from the gas source valve to the controller and/or communication of a target status from the controller to the gas source valve.

15. A cleaning system according to claim 1, the system further comprising a fluid valve configured to control flow of fluid from the tank outlet and wherein the controller is connectable to the fluid valve to allow communication of a status of the fluid valve from the fluid valve to the controller and/or communication of a target status from the controller to the fluid valve.

16. A cleaning system according to claim 14, the controller being configured to communicate with the gas source valve and the fluid valve to open the two valves according to a pre-programmed timetable to cause fluid from the tank to be expelled from the nozzle outlet.

17. A cleaning system according to claim 1, the system further comprising a tank pressure regulator being configured to control a pressure provided at the tank gas inlet, wherein the controller is communicatively connectable to the tank pressure regulator to allow communication of the pressure at the tank pressure regulator to the controller and communication of a target pressure to the tank pressure regulator.

18. A cleaning system according to claim 1, the system further comprising a nozzle pressure regulator being configured to control a pressure provided at the nozzle gas inlet, wherein the controller is communicatively connectable to the nozzle pressure regulator to allow communication of the pressure at the nozzle pressure regulator to the controller and communication of a target pressure to the nozzle pressure regulator.

19. A cleaning system according to claim 1, the system further comprising a fluid measurement means configured to measure the amount of fluid expelled from or amount of fluid within the tank, wherein the controller is communicatively connectable to the fluid measurement means to allow communication of the measurement to the controller.

20. A cleaning system according to claim 19, wherein the controller is communicatively connectable to a software system and the controller is configured to send reports indicative of the performance of the system to said software system.

21. A method of installation of a cleaning system for extraction and ventilation ducts comprising: providing a cleaning system according to claim 1, and locating the nozzle in a duct of the extraction and ventilation ducts.

22. A method of preventing the build-up of fats, oils or grease on an internal surface of a ventilation or extraction duct, the method comprising:
providing a cleaning system comprising:
a pressurised gas source,
a fluid supply tank containing a cleaning fluid, the fluid supply tank comprising a tank gas inlet fluidly connected to the pressurised gas source and a tank fluid outlet,
a nozzle, wherein the nozzle comprises a nozzle gas inlet, a nozzle fluid inlet and a nozzle outlet, and wherein the pressurised gas source is fluidly connected to the nozzle gas inlet and the fluid supply tank outlet is fluidly connected to the nozzle fluid inlet, wherein the nozzle outlet is located in the ventilation or extraction duct, and
a controller, the controller configured to control:
flow of gas from the pressurised gas source to the fluid supply tank gas inlet, and to the nozzle gas inlet and
operating the cleaning system, via the controller to expel the cleaning fluid from the nozzle outlet into the ventilation or extraction duct.
